(19) United States
(12) Patent Application Publication
(10) Pub. No.: US 2008/0201964 A1
(43) Pub. Date: Aug. 28, 2008

(54) Dual-Cut Saw Blade

(76) Inventors: Carlos Augusto de Camargo, Sao Paulo (BR); Max Ashton, Savoie (FR)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/934,926

(22) Filed: Nov. 5, 2007

Related U.S. Application Data
(60) Provisional application No. 60/891,610, filed on Feb. 26, 2007.

(51) Int. Cl. B26B 9/00; B26B 9/02; B26D 1/00

(52) U.S. Cl. 30/353; 30/355; 83/13

(57) ABSTRACT

A saw blade having a concavely curved sawing edge and two oppositely-directed sets of teeth. During reciprocation of the blade, a first set of the teeth may cut during a first stroke direction and the second set of teeth may cut during a second stroke direction.

### CROSS-REFERENCE TO RELATED APPLICATIONS

This application claims the benefit of the filing date of U.S. Provisional Patent Application Ser. No. 60/891,610, filed Feb. 26, 2007, the teachings of which are hereby incorporated herein by reference.

### TECHNICAL FIELD

The present disclosure relates to saw blades, and, in particular, to a dual-cut saw blade configured for cutting on each stroke of the blade.

### BACKGROUND

Reciprocating saws, such as jig saws, generally cause longitudinal reciprocation of a blade in a continuous cycle of first strokes that are directed away from the saw and second strokes and toward the saw. A conventional blade has a sawing edge for cutting material to be sawn during a “cutting” one of the first or second strokes, and for clearing away residue, such as saw dust or shavings, from the sawing edge during the “clearing” other one of the strokes. When the blade extends completely through the material being sawn during at least a portion of the reciprocation, such a cut is known as a through-cut. When blade projects into the material but not fully through it, such a cut is known as a plunge-cut. The slot or groove created in the sawn material as the blade passes through and makes its cut is known as a kerf. The cut edge of the sawn material left after the cut is complete is known as the sawn edge.

It is sometimes desirable that the blade leave a kerf or sawn edge that is as smooth, straight, clean, and free of sawing artifacts, chips, burrs and other blade vestiges as possible. It is a common though undesirable result of the differing effects caused by the cutting and clearing strokes that known blades leave different kerf or sawn edge quality during cutting than during clearing. In some materials, the kerf or sawn edge quality may be significantly worse on one side of the material than on the other. Generally, when a cutting tooth exits the material in its cutting direction while cutting, it may leave a less desirable kerf or sawn edge on that side of the material.

### BRIEF DESCRIPTION OF THE DRAWINGS

Features and advantages of embodiments of the disclosed subject matter will become apparent as the following Detailed Description proceeds, and upon reference to the Drawings, where like numerals depict like parts, and in which:

FIG. 1 is a partial close-up view of the cutting teeth of a prior art saw blade;

FIG. 2 is a profile view of a saw blade according to one exemplary embodiment consistent with the present disclosure;

FIG. 3 is a partial close-up view of the longitudinally central portion of the sawing edge of the blade of FIG. 2;

FIG. 4 is a perspective view of the blade of FIG. 2; and

FIG. 5 is a partial sectional view of a jigsaw having a blade as shown in FIG. 2.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

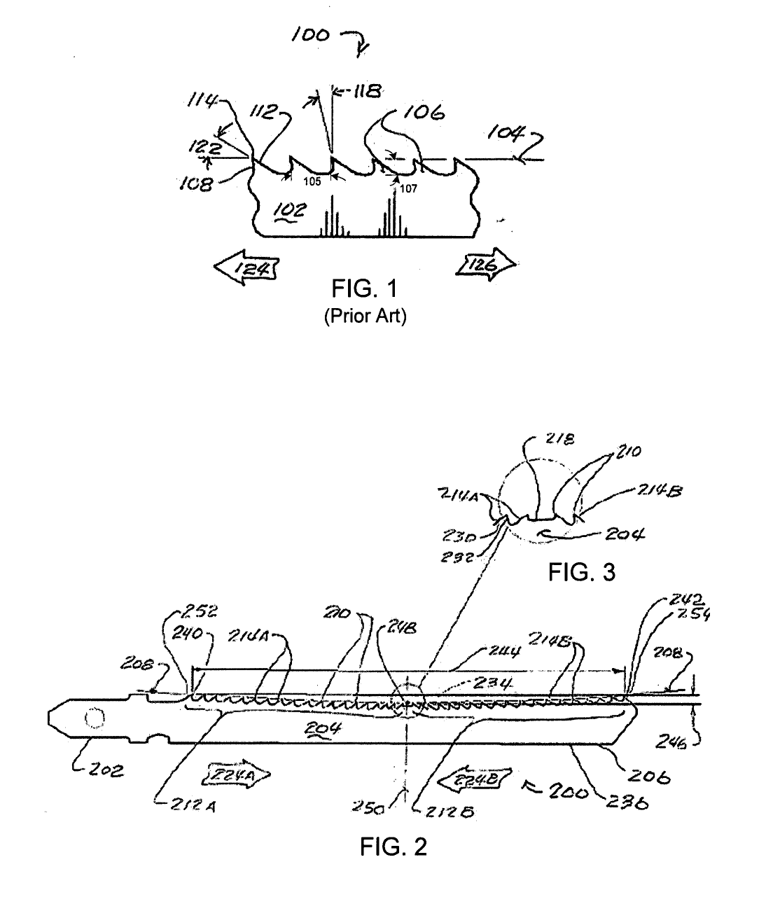

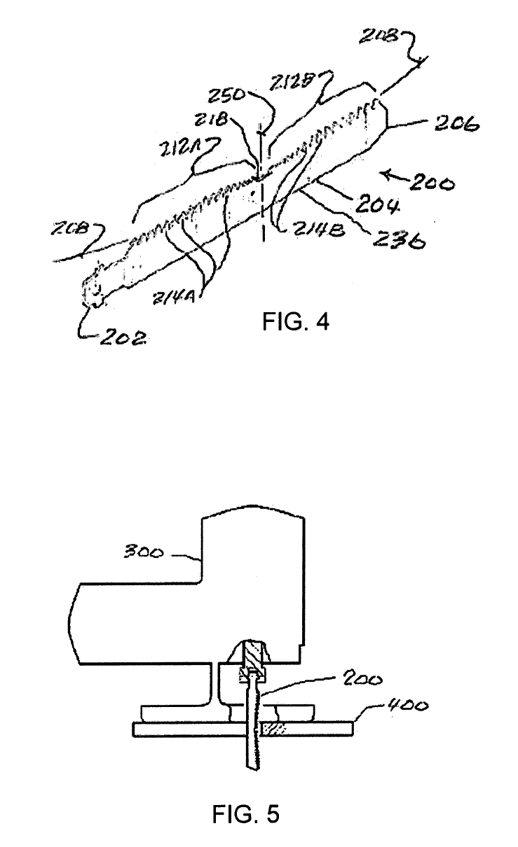

Turning to FIG. 1, definitions of typical saw blade terminology and features are discussed with reference to a blade of the prior art shown in FIG. 1. One exemplary embodiment of a dual-cut saw blade consistent with the present disclosure is then discussed with reference to FIGS. 2 through 5. Although the description provided herein is with reference to various exemplary embodiments, it is to be understood that the embodiments described herein are presented by way of illustration, not of limitation. Also, a saw blade consistent with the present disclosure may be incorporated into a variety of systems without departing from the spirit and scope of the invention.

Saw blades such as prior art blade 100 may share certain common features. Blade shank 102 has spaced longitudinally there-along a plurality of cutting teeth 106. Each cutting tooth is defined by its rake edge 108 and relief edge 112, which meet at the tooth's cutting tip 114. The distance 105 between successive cutting tips is the tooth spacing. The distance 107 from a cutting tip to the bottom of gullet is the gullet depth or tooth height.

A sawing edge 104 is defined by the line containing the plurality of cutting tips 114 and may be generally straight and parallel with the cutting and clearing motions of the blade, represented by arrows 124 and 126 respectively. A rake angle 118 is the angle between the rake edge 108 and a line projecting normally outward from sawing edge 104. A relief angle 122 is the angle between the relief edge 112 and the line defining sawing edge 104.

The direction from the relief edge toward the rake edge of a cutting tooth is known as the cutting direction, shown by arrow 124. Travel of the blade in the cutting direction is termed the cutting stroke. Sawing occurs when blade 100 moves against material in the cutting direction during a cutting stroke.

The direction from the rake edge towards the relief edge of a cutting tooth is known as the clearing direction, shown by arrow 126. Travel of the blade in the clearing direction is termed the clearing stroke. Debris and cutting residue is removed from the blade and the cutting tips are cleared when blade 100 moves against material in the clearing direction during a clearing stroke.

When cutting blades such as blade 100 are adapted for use in jigsaws or other such reciprocating saws, they may include a proximal end and an elongate shank portion. The proximal end may be shaped and configured for engagement with and attachment to the saw. Activation of the saw may cause longitudinal reciprocation of the blade in a continuous cycle of cutting strokes directed away from or toward the saw and clearing strokes directed opposite the cutting strokes.

The shank portion of such a reciprocating saw blade may extend from the proximal end toward a terminal distal end and into or through a material to be sawn. The shank portion has at least one sawing edge, such as sawing edge 104. The sawing edge may engage and cut the material to be sawn during the cutting strokes and clear away residue from the sawing edge, such as saw dust or shavings, during the clearing strokes.

The cutting and clearing strokes may have different effects on the quality of the kerf and/or sawn edge. For example, undesirable burring and chipping may result from the cutting tips as the cutting teeth exit from the material on the rake side of the material in the cutting stroke. In the clearing stroke, undesirable galling may result from pressure applied by the cutting tips as the cutting teeth exit from the material on the relief side of the material.

Turning now to FIGS. 2 though 4, there is shown one exemplary embodiment of a blade 200 consistent with the present disclosure. FIG. 5 illustrates the blade 200 coupled to a jigsaw. In the illustrated exemplary embodiment, the proximal end 202 of blade 200 is shaped and configured for fixed engagement with a jigsaw, such as jigsaw 300 of FIG. 5. The particular shape and configuration of the proximal end may be varied according to any known or later developed shape and configuration to allow the blade to be fixedly engaged with the saw.

Shank 204 extends from proximal end 202 away from the saw toward distal end 206, and includes sawing edge 208. The sawing edge 208 is defined by the concave line containing cutting tips 210 of a first plurality 212A of cutting teeth 214A and a second plurality 212B of cutting teeth 214B. In the illustrated exemplary embodiment, the first plurality 212A may be equal or approximately equal to the second plurality.

Henceforth in this disclosure, when elements or features of the first plurality 212A are discussed collectively, they will be referred to with an item number ending in a letter “A”, such as “cutting teeth 214A”, and when elements or features of the second plurality 212B are discussed collectively, they will be referred to with an item number ending in a letter “B”. When elements or features are discussed individually in a context independent of its plurality, they will be referred to only by their base item number, such as “cutting tooth 214”, which tooth could be either one of teeth 214A or 214B.

In the illustrated embodiment, a transition 218 is provided between the first 214A and second 214B pluralities of cutting teeth. At least a portion of the transition may be disposed below the sawing edge 208. In the illustrated embodiment, the transition is defined by a straight line extending between the teeth immediately adjacent opposite sides of the midline and is symmetrically centered on the sawing edge. It is to be understood, however, that the transition 218 may be offset from the longitudinal midline. Also, the transition may take other regular or irregular geometric configurations. For example, the transition may be concave or may include one or more teeth, e.g. a single tooth disposed on the midline 250. Transition 218 may be beneficial in providing a trap to collect cutting debris and residue during sawing, and to thereby reduce galling, cutting tip dulling, and other undesirable effects caused if such debris and residue were allowed to otherwise remain on and between the cutting teeth or to be forced between the shank of the blade and the inside edges of the kerf.

Each cutting tooth 214 has a cutting direction from its relief edge 230 towards its rake edge 232. Sawing by any particular tooth occurs when that tooth moves against material in its cutting direction. Each cutting tooth 214 also has a clearing direction from its rake edge 232 towards its relief edge 230. Debris and cutting residue is removed from any particular tooth and that tooth's cutting tip is cleared when that tooth moves against the material in its clearing direction.

The reciprocating motion of blade 200 may be aligned longitudinally with shank 204 and generally normally to the top surface of the material to be sawn. The reciprocating motion may be parallel with arrows 224A and 224B. Arrow 224A represents a portion of the blade's cycling stroke that is directed away from the saw, and arrow 224B represents a portion of the cycling stroke directed toward the saw.

The cutting direction of cutting teeth 214A is in the direction of arrow 224A, and the clearing direction of this plurality of teeth is in the direction of arrow 224B. Teeth 214A therefore saw material during that portion of the blade's reciprocation in the direction of arrow 224A. Conversely, the cutting direction of cutting teeth 214B is in the direction of arrow 224B and teeth 214B therefore saw material during that portion of the blade's reciprocation in the direction of arrow 224B.

In one embodiment, the blade may have symmetrical tooth configurations on opposite sides of the longitudinal midline 250. In such an embodiment, the blade 200 may be oriented to act against the material, such as material 400 of FIG. 5 during stroke portions 224A and 224B with generally equal but opposite effects against the material during either stroke portion 224A or 224B. It is to be understood, however, that the teeth may be asymmetrically configured on opposite sides of the longitudinal midline and/or the transition may be offset from the longitudinal midline. Also, the effect of the blade on the material may be asymmetrical, e.g. through selective orientation of the angle of the blade to the material during sawing.

As shown, the sawing edge 208 of the blade 200 is concave relative to a straight line 234 projecting between cutting tip 240 of proximal tooth 252 and cutting tip 242 of distal tooth 254. Proximal tooth 252 is the tooth of the first plurality 212A that is closest to proximal end 202 and distal tooth 254 is the tooth of the second plurality 212B that is closest to distal end 206. In the illustrated exemplary embodiment, the rear edge 236 of the blade is straight and lies parallel with straight line 234 and with stroke portions 224A and 224B. In such an embodiment, the concave cutting edge may curve inwardly toward the rear edge 236.

In the illustrated embodiment, the concave sawing edge curves inwardly from the line 234 in a generally continuous arc between the proximal 252 and distal 254 teeth with a generally flat portion between the teeth directly adjacent opposite sides of the transition 218. It is to be understood, however, that the concave sawing edge may take a variety of regular and irregular geometric configurations. For example, the concave cutting edge may have a generally parabolic shape, v-shape, irregular geometric shape, etc.

The ratio of the blade's cutting length to the depth of curvature of the sawing edge 208 may be established depending on the geometry of the concave sawing edge, the tooth configuration, the application and/or desired performance characteristics. The nadir, i.e. the lowest point or region, of the concave sawing edge may occur between the first and second plurality of teeth, e.g. on the longitudinal midline of the shank. In an embodiment including the illustrated exemplary concave geometry, for example, the longitudinal distance 244 between proximal tip 240 and distal tip 242 may be approximately 74 mm and the depth of curvature 246 of sawing edge 208, measured from line 234 connecting tips 240 and 242 to the nadir 248 of the of the sawing edge may be approximately 1.5 mm. In such an embodiment, the blade 200 has a ratio of cutting length to depth of approximately 50:1. Although any ratio of cutting length to depth may be provided in a blade consistent with the present disclosure, a ratio of cutting length to depth of between about 10:1 and 100:1 may be provided.

The concave cutting edge in the illustrated embodiment is formed by teeth having a generally uniform tooth height among the first and second plurality of teeth. It is to be understood, however, that a concave cutting edge 208 consistent with the present disclosure may be achieved using a progressive tooth height for the first and/or second plurality of teeth. For example, the tooth height may progressively decrease from the proximal 252 and/or distal 254 tooth to the tooth immediately adjacent the transition 218. Any one or more of the teeth in the first and/or second plurality of teeth may have height greater than any one or more of the other teeth in the first and/or second plurality of teeth. In fact, a concave cutting edge 208 consistent with the present disclosure may be achieved regardless of the specific tooth geometries or spacing.

The concave shape of sawing edge 208 may result in a decrease in the pressure applied by teeth 214A and 214B during travel in their clearing direction. This may reduce or eliminate undesirable burring and chipping on the rake side of the material and galling on the relief side of the material. The concave sawing edge may also cause each successive cutting tooth to bite deeper into the material than the tooth on its rake edge side thereby increasing overall cutting speed.

Referring now to FIG. 5, blade 200 is shown affixed to a typical jigsaw 300, in the act of through-sawing a piece of material 400. In operation, the saw may be disposed on the top surface of the material 400 with a shank of the blade extending beyond the bottom surface of the material. The saw may then be energized to cause continuous reciprocation of the blade. As the blade reciprocates in contact with the material, the blade may saw the material downwardly from the top surface during a down-stroke with a proximal plurality of downwardly-directed cutting teeth and upwardly from the bottom surface during an upstroke with a distal plurality of upwardly-directed cutting teeth.

Because sawing may occur during reciprocation of blade 200 in both directions, it is found that sawing efficacy and speed are increased compared to traditional blades. In addition, a blade consistent with the present disclosure may provide improved kerf and sawn edge quality during through cutting and plunge cutting, especially on brittle materials such as countertop laminates, which when sawn by traditional blades are especially prone to poor kerf and sawn edge quality on the side of the material exited by teeth during their cutting stroke.

According to one aspect of the disclosure there is provided a saw blade including: a first plurality teeth, each of the first plurality of teeth having a cutting tip directed toward a first end of the blade, and a second plurality, each of the second plurality of teeth having a cutting tip directed toward a second end of the blade and toward the first plurality of teeth. The first and second pluralities of teeth define a concave cutting edge.

According to another aspect of the disclosure there is provided a saw blade including: a proximal portion configured for fixed engagement with a saw; a shank portion; a first plurality teeth on the shank portion, each of the first plurality of teeth having a cutting tip directed toward a distal end of the blade; a second plurality on the shank portion each of the second plurality of teeth having a cutting tip directed toward a proximal end of the blade and toward the first plurality of teeth; and transition portion extending between the first and second plurality of teeth. The first plurality teeth include a proximal tooth adjacent a proximal end of the shank portion and having a proximal cutting tip, and the second plurality of teeth include a distal tooth adjacent a distal end of the shank portion and having a distal cutting tip, wherein a straight line connecting the proximal and distal cutting tips is parallel to a cutting direction of the first and second pluralities of teeth. The first and second pluralities of teeth defining a concave cutting edge extending inwardly from the straight line.

According to another aspect of the disclosure there is provided a method of sawing material including: engaging a blade of a reciprocating saw with the material, the blade including a first plurality teeth, each of the first plurality of teeth having a cutting tip directed toward a first end of the blade, and a second plurality, each of the second plurality of teeth having a cutting tip directed toward a second end of the blade and toward the first plurality of teeth, the first and second plurality of teeth defining a concave cutting edge; and energizing the saw to cause the continuous reciprocation of the blade with the blade in contact with the material.

The embodiments that have been described herein are set forth herein by way of illustration but not of limitation. Many other embodiments, which will be readily apparent to those of ordinary skill in the art, may be made without departing materially from the spirit and scope of the disclosure.

What is claimed is:

1. A saw blade comprising:
a first plurality teeth, each of said first plurality of teeth having a cutting tip directed toward a first end of the blade; and
a second plurality, each of said second plurality of teeth having a cutting tip directed toward a second end of said blade and toward said first plurality of teeth,
said first and second plurality of teeth defining a concave cutting edge.

2. A blade according to claim 1, said blade further comprising a transition portion extending between said first and second plurality of teeth, said transition portion being disposed inwardly from said concave sawing edge.

3. A blade according to claim 2, wherein said first and second pluralities of teeth are provided on a shank portion of said blade, and wherein said transition portion extends across a longitudinal midline of said shank portion.

4. A blade according to claim 1, wherein said first plurality is approximately equal to said second plurality.

5. A blade according to claim 1, wherein said first and second pluralities of teeth are provided on a shank portion of said blade and are symmetrically disposed on opposite sides of a longitudinal midline of said shank portion.

6. A blade according to claim 1, wherein said concave cutting edge extends from a one of said first plurality of teeth nearest said second end of said blade to one of said second plurality of teeth nearest said first end of said blade.

7. A blade according to claim 1, wherein said first and second pluralities of teeth are provided on a shank portion of said blade, and wherein said first plurality teeth comprises a proximal tooth adjacent a proximal end of said shank portion and having a proximal cutting tip; and said second plurality of teeth comprises a distal tooth adjacent a distal end of said shank portion and having a distal cutting tip, and wherein a straight line connecting said proximal and distal cutting tips is parallel to a cutting direction of said first and second pluralities of teeth.

8. A blade according to claim 7, wherein said straight line is parallel to a rear edge of said blade.

9. A blade according to claim 7, wherein said concave cutting edge line bows inwardly from and intersects with said straight line at said proximal and distal cutting tips.

10. A blade according to claim 7, wherein the ratio of the longitudinal distance between said proximal and distal cutting tips to the transverse distance between said straight line and a nadir of said concave cutting edge is between about 10:1 and 100:1.

11. A blade according to claim 1, wherein a nadir of said concave cutting edge occurs between said first and second pluralities of teeth.

12. A blade according to claim 1, wherein said first and second pluralities of teeth are provided on a shank portion of said blade, and wherein the nadir of said concave cutting edge is at a longitudinal midline of said shank portion.

13. A blade according to claim 1, said blade further comprising a proximal end configured for fixed engagement with a saw such that energization of the saw causes continuous reciprocation of the blade between movement in a first linear direction away from the saw, and a second linear direction toward the saw.

14. A saw blade comprising:
a proximal portion configured for fixed engagement with a saw;
a shank portion;
a first plurality teeth on said shank portion, each of said first plurality of teeth having a cutting tip directed toward a distal end of the blade;
a second plurality on said shank portion each of said second plurality of teeth having a cutting tip directed toward a proximal end of said blade and toward said first plurality of teeth; and
a transition portion extending between said first and second plurality of teeth,
said first plurality teeth comprising a proximal tooth adjacent a proximal end of said shank portion and having a proximal cutting tip, and said second plurality of teeth comprising a distal tooth adjacent a distal end of said shank portion and having a distal cutting tip, wherein a straight line connecting said proximal and distal cutting tips is parallel to a cutting direction of said first and second pluralities of teeth,
said first and second plurality of teeth defining a concave cutting edge extending inwardly from said straight line.

15. A blade according to claim 14, wherein said first and second pluralities of teeth are symmetrically disposed on opposite sides of a longitudinal midline of said shank portion.

16. A blade according to claim 14, wherein said straight line is parallel to a rear edge of said blade.

17. A blade according to claim 14, wherein said concave cutting edge intersects with said straight line at said proximal and distal cutting tips.

18. A blade according to claim 14, wherein the ratio of the longitudinal distance between said proximal and distal cutting tips to the transverse distance between said straight line and a nadir of said concave cutting edge is between about 10:1 and 100:1.

19. A blade according to claim 14, wherein the nadir of said concave cutting edge is at a longitudinal midline of said shank portion.

20. A method of sawing material comprising:
engaging a blade of a reciprocating saw with the material, said blade comprising:
a first plurality teeth, each of said first plurality of teeth having a cutting tip directed toward a first end of the blade, and
a second plurality, each of said second plurality of teeth having a cutting tip directed toward a second end of said blade and toward said first plurality of teeth,
said first and second plurality of teeth defining a concave cutting edge; and
energizing the saw to cause said continuous reciprocation of said blade with the blade in contact with the material.
